(19) United States
(12) Patent Application Publication
(10) Pub. No.: US 2024/0317647 A1
(43) Pub. Date: Sep. 26, 2024

(54) WASHCOAT METHOD

(71) Applicant: MICROTECH CERAMICS LIMITED, Loughborough Leicestershire (GB)

(72) Inventors: Dean Graeme OXLEY, Mansfield Nottinghamshire (GB); Nadia CROESER, Ruddington Nottinghamshire (GB); Benjamin Francis Knatchbull KINGSBURY, Rotherfield Sussex (GB)

(21) Appl. No.: 18/579,197

(22) PCT Filed: Jul. 14, 2022
(86) PCT No.: PCT/GB2022/051828

§ 371 Date: Jan. 12, 2024

(30) Foreign Application Priority Data
Jul. 15, 2021 (GB) 2110212.4

(51) Int. Cl. C04B 35/622; B01D 53/86; C04B 38/00; F01N 3/28

(52) U.S. Cl. CPC C04B 35/62222; B01D 53/86; C04B 38/0096; F01N 3/2828; B01D 2258/01; C04B 2235/94; F01N 2330/06

(57) ABSTRACT

A method of washcoating a porous ceramic substrate, the method comprising:
(i) pre-treating the substrate to form a pre-treated substrate;
(ii) contacting the pre-treated substrate with a washcoat composition, wherein the washcoat composition comprises a washcoat solvent and a refractory material (such as a high surface area refractory material),
wherein step (i) comprises pre-treating the substrate so as to substantially prevent ingress of the washcoat solvent into pores of the substrate and wherein the porous ceramic substrate comprises a plurality of channels and a plurality of micro-channels.

### FIELD OF THE INVENTION

The present invention relates to a method of washcoating a porous ceramic substrate and a washcoated porous ceramic substrate. The present invention also relates to a method of manufacturing a filter (such as a diesel particulate filter), a method of filtering and a filter (such as a diesel particulate filter). The present invention also relates to a method of manufacturing a catalytic convertor, a method of catalytic conversion of pollutants, a catalytic convertor, a method of manufacturing an exhaust system, an exhaust system, a method of manufacturing a product including an internal combustion engine and such a product.

### BACKGROUND

The combustion of fuel in internal combustion engines (present in various products, especially vehicles) results in the production of exhaust gases which contain pollutants which are harmful to human health and the environment. Modern vehicles (and other products including internal combustion engines) are therefore equipped with exhaust systems designed to reduce such pollutants. For example, vehicle exhaust systems typically comprise catalytic convertors for reducing the emission of carbon monoxide, hydrocarbons and nitrogen oxides (NOx), and for example diesel particulate filters (DPF) or gasoline particulate filters (GPF) for reducing the emission of soot.

Known catalytic convertors comprise a ceramic substrate having a catalytically active coating applied thereon (which catalytically active coating may comprise a platinum group metal (PGM)). The catalytically active coating is typically applied to the substrate as a component of a washcoat or to a washcoat already applied to the substrate.

Known diesel particulate and gasoline particulate filters also comprise a ceramic substrate, which substrate is adapted to capture and store exhaust particulates (such as soot) present in the exhaust gases, thereby reducing the emission of such particulates. The substrates of such filters may also comprise a catalytically active coating applied thereon.

Other filters are known (such as water filters) that comprise a ceramic substrate. Such a filter may not comprise a catalytically active coating but may have a coating applied thereto that aids filtration and/or, for example, cleansing.

Conventional ceramic substrates comprise numerous channels through which fluids such as exhaust gases or liquids (for example water) pass. The substrates are also porous, such that the walls of the channels comprise pores. The channel structure of the substrate provides a large geometric surface area (GSA), which may support a washcoat, such as a highly porous, high surface area washcoat. A coating, such as a catalytically active coating, can be deposited on or in the washcoat, thereby providing the substrate with a desired functionality, such as catalytic convertor functionality. The coated substrate must also provide desirable flow characteristics. For example, in the case of a catalytic convertor, the coated substrate must provide desirable gas flow characteristics so as to provide the required gas-catalyst contact without excessive back pressure which may be detrimental to the performance of an internal combustion engine in which the substrate is assembled. At least the composition and quantity of the washcoat and the catalytically active coating must be carefully selected/optimised so that the desired conversion efficiency and flow characteristics are achieved.

Alternative ceramic substrates are described in WO 2013/175239 and WO 2015/033157. The alternative ceramic substrates comprise channels and micro-channels as well as being porous. The micro-channels increase the GSA, but conventional washcoating methods have been found to be inefficient in coating both the channels and micro-channels of these substrates. In particular, a major disadvantage is that the washcoating does not readily enter the micro-channels using conventional washcoating methods and consequently the surface area provided by the internal surfaces of the micro-channels is not utilisable to provide catalytic conversion functionality.

It is one aim of the present invention, among others, to provide a method of washcoating a porous ceramic substrate (wherein the substrate comprises channels and micro-channels as well as being porous) that addresses at least one disadvantage of the prior art, whether identified here or elsewhere, or to provide an alternative to existing methods of washcoating a porous ceramic substrate. For instance, it may be an aim of the present invention to provide a method of washcoating a porous ceramic substrate that provides an optimal washcoat on the substrate (particularly on the micro-channel surfaces), for example which provides optimal catalytic efficiency and flow characteristics when the substrate is incorporated into an exhaust system of a product such as a vehicle (for example as a component of a catalytic convertor and/or a filter, such as a diesel or gasoline particulate filter) or which provides optimal filtering efficiency and flow characteristics when the substrate is incorporated into a filter (such as a water filter).

### SUMMARY

According to a first aspect of the present invention, there is provided a method of washcoating a porous ceramic substrate, the method comprising:
(i) pre-treating the substrate to form a pre-treated substrate;
(ii) contacting the pre-treated substrate with a washcoat composition, wherein the washcoat composition comprises a washcoat solvent and a refractory material (such as a high surface area refractory material),
wherein step (i) comprises pre-treating the substrate so as to substantially prevent ingress of the washcoat solvent into pores of the substrate and wherein the porous ceramic substrate comprises a plurality of channels and a plurality of micro-channels.

According to a second aspect of the present invention, there is provided a washcoated porous ceramic substrate obtained by the method of the first aspect of the invention.

According to a third aspect of the present invention, there is provided a washcoated porous ceramic substrate comprising a plurality of micro-channels coated with a solid washcoat layer, wherein the quantity of the washcoat layer is proportional to the volume of the micro-channels.

According to a fourth aspect of the present invention, there is provided a method of manufacturing a filter, the method comprising manufacturing a washcoated porous ceramic substrate according to the first aspect of the invention and blocking at least some channels in the substrate.

According to a fifth aspect of the present invention, there is provided a method of filtering, the method comprising manufacturing a filter according to the fourth aspect of the invention and passing a composition through the filter.

According to a sixth aspect of the present invention, there is provided a filter comprising a washcoated porous ceramic substrate according to the second or third aspect of the invention.

According to a seventh aspect of the present invention, there is provided a method of manufacturing a catalytic convertor, the method comprising manufacturing a washcoated porous ceramic substrate according to the first aspect of the invention and optionally depositing a catalytic species or precursor thereof on the washcoat.

According to an eighth aspect of the present invention, there is provided a method of catalytic conversion of pollutants, the method comprising manufacturing a catalytic convertor according to the seventh aspect of the invention and passing a pollutant composition through the catalytic convertor.

According to a ninth aspect of the present invention, there is provided a catalytic convertor comprising a washcoated porous ceramic substrate according to the second or third aspects of the invention.

According to a tenth aspect of the present invention, there is provided a method of manufacturing an exhaust system, the method comprising:
manufacturing a filter according to the fourth aspect of the invention and incorporating the filter into an exhaust system; and/or
manufacturing a catalytic convertor according to the seventh aspect of the invention and incorporating the catalytic convertor into an exhaust system.

According to an eleventh aspect of the present invention, there is provided an exhaust system comprising a filter according to the sixth aspect of the invention and/or a catalytic convertor according to the ninth aspect of the invention.

According to a twelfth aspect of the present invention, there is provided a method of manufacturing a product including an internal combustion engine (such as a vehicle), the method comprising manufacturing an exhaust system according to the tenth aspect of the invention and incorporating the exhaust system into a product including an internal combustion engine (such as a vehicle).

According to a thirteenth aspect of the present invention, there is provided a product including an internal combustion engine (such as a vehicle) comprising an exhaust system according to the eleventh aspect of the invention.

### DETAILED DESCRIPTION

Unless otherwise stated, the following terms used in the specification and claims have the meanings set out below.

As used herein, the terms “washcoat” or “washcoating” are used in their ordinary sense, which is well-known to those skilled in the art. Specifically, these terms refer to a thin layer or applying a thin layer of a washcoat composition (typically comprising a refractory material, such as a high surface area refractory material, for example a metal oxide) applied to a substrate. The washcoat typically provides the high surface area needed for the dispersion of catalytic species and precursors thereof.

As used herein, the term “ceramic” is used in its ordinary sense, which is well-known to those skilled in the art. Specifically, a ceramic is an inorganic, nonmetallic solid, generally based on an oxide, nitride, boride, or carbide, that is fired at a high temperature.

As used herein, the term “substrate” is used in its ordinary sense, which is well-known to those skilled in the art. Specifically, a substrate is an underlying substance upon which another substance, such as a washcoat may be applied. In some embodiments, a substrate may be used without another substance applied, such as without a washcoat applied. The substrate may take any suitable form, such as a tubular, non-tubular, or sheet form. The substrate may comprise a plurality of parallel, fused hollow fibres. Such substrates may comprise channels that are open macro-channels within the hollow fibres (e.g. the bore of the hollow fibres), as well as micro-channels in the porous walls of the hollow fibres.

By “macro-channels” we mean channels penetrating through the substrate having a minimum diameter (i.e. at the narrowest part of the channel) of greater than 0.2 mm, such as greater than 5 mm, or even greater than 1 mm. References herein to “channels” are intended to refer to macro-channels.

By “micro-channels” we mean channels penetrating through the walls of the macro-channels having an entrance diameter of 5 μm to 200 μm.

The walls of the substrate are porous, i.e. comprise pores. Pore diameters are typically less than 5 μm, such as from 0.1 to 4.9 μm.

As used herein, the term “refractory material” is used in its ordinary sense, which is well-known to those skilled in the art. Specifically, a refractory material is a material that is resistant to high temperatures (such as above 538° C.).

As used herein, the term “high surface area refractory material” is used in its ordinary sense, which is well-known to those skilled in the art. Specifically, a high surface area refractory material is a material that has a high surface area of greater than 20 m²/g and that is resistant to high temperatures (such as above 538° C.). The high surface area refractory material may have a high surface area of greater than 30 m²/g, or greater than 50 m²/g. The high surface area of the refractory material may be measured by BET techniques as known to persons skilled in the art.

By “functional species” we mean a chemical species that provides the substrate with a desired functionality when applied thereto. For example, the functional species may be a catalytic species or a cleansing species.

As used in the specification and the appended claims, the singular forms “a”, “an,” and “the” include both singular and plural referents unless the context clearly dictates otherwise. By way of example, “a catalytic species” means one catalytic species or more than one catalytic species. Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and may also be taken to include the meaning “consists of” or “consisting of”.

For the avoidance of doubt, where amounts of components in a composition are described in wt %, this means the weight percentage of the specified component in relation to the whole composition referred to.

As used herein, unless otherwise expressly specified, all numbers such as those expressing values, ranges, amounts of percentages may be read as if prefaced by the word “about”, even if the term does not expressly appear.

The term “about” as used herein when referring to a measurable value such as a parameter, an amount, a temporal duration, and the like, indicate that a value includes the standard deviation of error for the device or method being employed to determine the value. The term “about” is meant to encompass variations of +/−10% or less, +/−5% or less, or +/−0.1% or less of and from the specified value, insofar such variations are appropriate to perform in the disclosure. It is to be understood that the value to which the modifier “about” refers is itself also specifically disclosed.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary embodiment of the invention, as set out herein are also applicable to any other aspects or exemplary embodiments of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

According to a first aspect of the present invention, there is provided a method of washcoating a porous ceramic substrate, the method comprising:
(i) pre-treating the substrate to form a pre-treated substrate;
(ii) contacting the pre-treated substrate with a washcoat composition, wherein the washcoat composition comprises a washcoat solvent and a refractory material (such as a high surface area refractory material),
wherein step (i) comprises pre-treating the substrate so as to substantially prevent ingress of the washcoat solvent into pores of the substrate and whereinthe porous ceramic substrate comprises a plurality of channels and a plurality of micro-channels.

The method of the first aspect of the invention is for applying a layer of a washcoat to a porous ceramic substrate, for example to the channel and micro-channel (especially micro-channel) surfaces of the substrate (and substantially not to the pores).

The micro-channels typically extend from one surface to another surface and have an entrance diameter of 5 μm to 200 μm. The method of the first aspect of the invention advantageously coats the surfaces/walls of the micro-channels with the washcoat, thereby providing a high loading or quantity of the refractory material (for example high surface area refractory material) onto the substrate. This in turn allows for a high loading of a functional species, such as a catalytic species or precursor thereof or a source of silver ions, coated on or in the washcoat layer. The method of the first aspect of the invention may also prevent destabilisation of the washcoat composition, so as to prevent the formation of a cake layer on the substrate surface. This provides advantages in use of the substrate, for example as a component of a catalytic convertor and/or filter.

In the method of the first aspect of the invention, the substrate is subjected to a pre-treatment step (i) prior to contact with the washcoat composition, i.e. so as to provide a pre-treated substrate. References herein to the “pre-treated substrate” are intended to refer to the substrate after pre-treatment in step (i) and prior to contacting with the washcoat composition. The pre-treatment step (i) acts to substantially prevent ingress of the washcoat solvent into pores of the substrate. Thus, the pre-treatment step (i) changes the properties of the substrate so as to improve the subsequent washcoating of the substrate.

The ingress of washcoat solvent into pores of the substrate may be prevented by different means. For example, the washcoat solvent may be substantially prevented from entering the pores by saturating or filling the pores of the substrate with a substance, such as a solvent, in the pre-treatment step, so as to prevent the washcoat solvent from also entering the pores. Alternatively, this may be achieved by coating the substrate with a substance that repels the washcoat solvent, such that the washcoat composition is prevented from entering the pores of the substrate. The substance may also preferentially bind with components of the washcoat composition other than the washcoat solvent. For example, when the washcoat solvent is hydrophilic, the substrate may, in the pre-treatment step, be coated with a hydrophobic substance so as to repel the hydrophilic washcoat solvent and optionally form chemical bonds between the hydrophobic substance and non-solvent components of the washcoat composition.

By reference to the pre-treatment step (i) acting to “substantially prevent” ingress of the washcoat solvent into pores of the substrate, we mean that at least 80% of the washcoat solvent contacted with the pre-treated substrate is prevented from entering and occupying the pores of the substrate. For example, at least 90%, at least 95%, or even 100%, of the washcoat solvent contacted with the pre-treated substrate may be prevented from entering and occupying the pores of the substrate.

In the method of the first aspect of the invention, the ingress of the washcoat solvent into pores of the substrate may be substantially prevented by reducing or preventing capillary action of the pores. In other words, the substrate may be pre-treated so as to substantially prevent or reduce the ability of the washcoat solvent to flow into and occupy pores in the substrate.

In the method of the first aspect of the invention, the ingress of the washcoat solvent into pores of the substrate may be prevented by increasing the hydrophobicity of the substrate. This pre-treatment step may advantageously be used when the washcoat solvent is hydrophilic. By the term “increasing the hydrophobicity” we mean to make the substrate more hydrophobic than before the pre-treatment. As the skilled person would appreciate, such a change in hydrophobicity of a substrate may be determined by measuring the contact angle between water and the surface, wherein a change in contact angle represents a change in hydrophobicity and a contact angle of greater than 90° C. representing a hydrophobic substrate. Contact angles can be measured according to any suitable method, such as ISO 19403-6:2020. As an alternative to contact angle, a change in hydrophobicity may be determined by means of a water absorption test, i.e. wherein the untreated substrate absorbs water, but water sits as a droplet on the surface of the substrate once the substrate is hydrophobic.

Step (i) of the method of the first aspect of the invention may comprise contacting the substrate with a pre-treatment composition, wherein the pre-treatment composition comprises a first pre-treatment solvent and a hydrophobic compound. In this case, pores and micro-channels of the substrate become filled with the pre-treatment composition (including the hydrophobic compound) and coated with the hydrophobic compound, thereby increasing the hydrophobicity of the substrate.

Any suitable hydrophobic compound may be used. The hydrophobic compound should provide a contact angle of greater than 900 when coated on the substrate. The hydrophobic compound should be dispersible in the first pre-treatment solvent and be suitable for filling and coating pores and micro-channels of the substrate. The hydrophobic compound may be insoluble in water. The hydrophobic compound may preferentially bind with components of the washcoat composition other than the washcoat solvent, such as particles of refractory material (such as of high surface area refractory material) dispersed or suspended in the washcoat solvent or functional species dissolved in the washcoat solvent,

Examples of suitable hydrophobic compounds include hydrophobic C4 to C12 fatty acids (such as caprylic acid, capric acid and lauric acid) and surface modification compounds (such as 1H,1H,2H,2H-perfluorodecyldimethylchlorosilane (PFMS)), or a combination thereof. Examples of suitable polyelectrolyte compounds that preferentially bind to non-solvent components of the washcoat composition include PEG-30 dipolyhydroxystearate, which is available commercially as Cithrol™ DPHS from Croda.

Any suitable first pre-treatment solvent may be used. The first pre-treatment solvent should be suitable for dispersing the hydrophobic compound therein. The first pre-treatment solvent should be readily removed from the substrate so as to retain the hydrophobic compound on the substrate as a residue/coating. Examples of suitable first pre-treatment solvents include alcohols (for example C1-C6 alcohols, such as methanol, ethanol and isopropyl alcohol), ketones (such as acetone or 2-butanone) and toluene, or a combination thereof.

The pre-treatment composition may comprise any suitable ratio of the first pre-treatment solvent and the hydrophobic compound. For example, the pre-treatment composition may comprise the first pre-treatment solvent and the hydrophobic compound in a weight ratio of 85:15 to 98:2.

When step (i) comprises contacting the substrate with a pre-treatment composition, there may be a further step of removing the first pre-treatment solvent from the substrate. This provides a substantially dry pre-treated substrate comprising the hydrophobic compound as a residue on or chemically bonded to the substrate, thereby increasing the hydrophobicity of the substrate.

In particular, the hydrophobic compound is provided as a residue (or coating) on the pores and micro-channels of the substrate.

In the method of the first aspect of the invention, the pre-treatment step (i) may comprise:
(ia) contacting the substrate with a pre-treatment composition, wherein the pre-treatment composition comprises a first pre-treatment solvent and a hydrophobic compound, and
(ib) removing the first pre-treatment solvent from the substrate.

The step (ia) above should be conducted for a sufficient period of time to enable complete wetting of the substrate with the pre-treatment composition.

In the method of the first aspect of the invention, the ingress of the washcoat solvent into pores of the substrate may be prevented by substantially saturating the pores of the substrate with a second pre-treatment solvent.

Step (i) of the method of the first aspect of the invention may comprise contacting the substrate with a second pre-treatment solvent so as to substantially saturate the pores of the substrate with the second pre-treatment solvent.

By reference to “substantially saturating” the pores of the substrate with the second pre-treatment solvent, we mean that at least 80% of the pores of the substrate are occupied by the second pre-treatment solvent in the pre-treatment step (i). For example, at least 90%, at least 95%, or even 100%, of the pores of the substrate are occupied by the second pre-treatment solvent in the pre-treatment step (i).

Any suitable second pre-treatment solvent may be used, which solvents should be readily absorbed (for example by capillary action) into pores of the substrate. Examples of suitable second pre-treatment solvents include water (such as deionized water), methanol, ethanol, propanol, butanol, acetone, ethylene glycol, butanediol, glycerol, tetrahydrofuran, formic acid, acetic acid, and combinations thereof. Suitably, the second pre-treatment solvent is a solvent that has a contact angle with the refractory material (for example high surface area refractory material) of less than 90°.

Suitably, the second pre-treatment solvent and the washcoat solvent are the same. Preferably, the second pre-treatment solvent and the washcoat solvent comprise water. The use of water as both the washcoat solvent and the second pre-treatment solvent is advantageous as it is environmentally acceptable and easy to handle and store.

Following the pre-treatment step (i), the pre-treated substrate is washcoated.

The washcoat composition comprises a washcoat solvent and a refractory material (such as a high surface area refractory material). The refractory material (for example high surface area refractory material) may form a dispersion, suspension or a solution with the washcoat solvent. Any suitable refractory material may be used, which will be selected depending on the intended use of the washcoated substrate. Suitable refractory materials would be well known to persons skilled in the art.

Any suitable high surface area refractory material may be used, which will be selected depending on the intended use of the washcoated substrate. Suitable high surface area refractory materials would be well known to persons skilled in the art.

The refractory material (for example high surface area refractory material) may comprise a ceramic material, suitably a ceramic material having a high specific (intrinsic) surface area (such as selected from alumina, silica, silicon carbide, boehmite and zeolite, for example selected from gamma-alumina, boehmite, zeolite and silica).

The refractory material may be a high surface area refractory material that comprises a ceramic material having a high specific (intrinsic) surface area (such as selected from alumina, silica, silicon carbide, boehmite and zeolite, for example selected from gamma-alumina, boehmite, zeolite and silica).

The refractory material (for example high surface area refractory material) may comprise a metal oxide or a precursor thereof.

The refractory material may be a high surface area refractory material that comprises a metal oxide or a precursor thereof.

Examples of suitable metal oxides include alumina (such as gamma-alumina), zirconia, yttrium-stabilised zirconia, lanthanum strontium cobalt ferrite, nickel oxide and titania.

The refractory material (for example high surface area refractory material) may comprise a metal oxide and a metal, for example a combination of nickel oxide and nickel. This may provide a conductive substrate.

The refractory material may be a high surface area refractory material that comprises a metal oxide and a metal, for example a combination of nickel oxide and nickel.

Examples of suitable metal oxide precursors include boehmite, which is a precursor material that converts to gamma-alumina upon heating for example to temperatures of 550° C. Boehmite is typically provided as a dispersion in a solvent such as water. The solid content of the boehmite in the solvent is typically 5 to 40 wt %, such as 10 to 30 wt %. Metal oxide precursors such as boehmite may be selected according to their particle size, so as to ensure that the metal oxide precursor may coat the surfaces of micro-channels in the substrate.

Examples of suitable metal oxide precursors include a metal species, such as a metal salt or an organometallic compound, that may convert to a metal oxide. Such a metal species may convert to a metal oxide for example by heating in the presence of oxygen (such as in air) so as to form the metal oxide. An example of a suitable metal salt may be aluminium nitrate which may convert to aluminium oxide (alumina) upon heating in air. An example of a suitable organometallic compound may be an organic polymer comprising aluminium located within the polymer chain, wherein the aluminium may convert to aluminium oxide (alumina) upon heating in air. The organic polymer comprising aluminium may form a gel when the washcoat solvent is removed, which gel may then be heated to form the aluminium oxide (alumina), i.e. by means of a sol-gel process. The use of such metal oxide precursors may allow for control of the structure of the resulting washcoated porous ceramic substrate.

The washcoat composition may comprise more than one refractory material (for example high surface area refractory material). Multiple washcoat compositions may be used, for example each comprising a different high surface area refractory material. Multiple washcoat compositions may be contacted with the substrate separately in a series of washcoating steps.

The washcoat composition may comprise 15 to 25 wt % of the refractory material (for example high surface area refractory material) and 85 to 75 wt % of the washcoat solvent.

Any suitable washcoat solvent may be used, which solvents would be well known to persons skilled in the art. The washcoat solvent should be suitable for dispersing or suspending the refractory material (for example high surface area refractory material) therein. Examples of suitable washcoat solvents include water (such as deionized water), methanol, ethanol, propanol, butanol or acetone. The use of water as the washcoat solvent is advantageous as it is environmentally acceptable and easy to handle and store.

The washcoat composition may comprise a catalytic species or precursor thereof. Suitable catalytic species may comprise a platinum group metal, for example selected from platinum, palladium or rhodium, or a combination thereof. When the washcoat composition comprises a catalytic species or precursor thereof, the catalytic species or precursor thereof may be applied to the substrate as a component of the washcoat. Alternatively, the catalytic species or precursor thereof may be applied to the washcoat layer after it has been formed on the substrate.

The washcoat composition may comprise an additional ingredient selected from a viscosity modifier, a stabilizer, a plasticizer, an antifoaming agent, or a combination thereof. Examples of suitable viscosity modifiers, stabilizers, plasticizers and antifoaming agents would be well known to persons skilled in the art. A suitable viscosity modifier may comprise polyvinylalcohol. A suitable stabilizer may comprise polyacrylic acid.

The washcoat composition may be prepared by combining and mixing the components thereof. Any suitable mixing technique may be used, including for example mixing with a stirrer, ultrasonic treatment or planetary mixing. Suitably the components of the washcoat composition are mixed so as to provide a stable and complete dispersion, suspension or solution of the refractory material (for example high surface area refractory material) in the washcoat solvent.

References herein to contacting the substrate with the washcoat composition, pre-treatment composition and second pre-treatment solvent refer to any means by which the substrate and the micro-channels thereof are brought into contact with the aforementioned compositions and solvents.

For example, the substrate may be contacted with the pre-treatment composition or second pre-treatment solvent by partially or fully immersing the substrate in the composition or solvent, by placing the substrate in contact with an alternative porous material soaked in the pre-treatment composition or second pre-treatment solvent, or by injecting the composition or solvent into the substrate (such as into the channels of the substrate). Suitably, the substrate may be contacted with the pre-treatment composition or second pre-treatment solvent by partially or fully immersing the substrate in the composition or solvent.

For example, the substrate may be contacted with the pre-treatment composition by partially or fully immersing the substrate in the composition, or by injecting the composition into the substrate (such as into the channels of the substrate). Suitably, the substrate may be contacted with the pre-treatment composition by partially or fully immersing the substrate in the composition.

For example, the substrate may be contacted with the second pre-treatment solvent by placing the substrate in contact with an alternative porous material soaked in the second pre-treatment solvent. The substrate may be contacted with the second pre-treatment solvent by exposing the substrate to a gaseous form of the second pre-treatment solvent (such as water vapour). These methods advantageously avoid saturating the micro-channels with the second pre-treatment solvent.

When the method comprises contacting the substrate with a second pre-treatment solvent, the substrate and solvent may be contacted for a sufficient period of time to allow the solvent to absorb into the pores and substantially saturate the pores. The period of time required to allow the solvent to absorb into the pores and substantially saturate the pores can be determined by known methods, such as by weighing the substrate at regular intervals to determine when the substrate weight is stable (indicating complete saturation).

In the washcoating step, the pre-treated substrate may, for example, be contacted with the washcoat composition by partially or fully submerging the substrate in the composition, or by injecting the composition into the substrate (such as into the channels of the substrate). The pre-treated substrate may be contacted with the washcoat composition for a sufficient period of time to allow the composition to fill the micro-channels (but not the pores) of the substrate. Suitably, the pre-treated substrate may be subjected to ultrasonication or to a pressure of 20 to 200 kPa upon contacting with the washcoat composition. When the pre-treated substrate is subjected to a pressure of 20 to 200 kPa upon contacting with the washcoat composition, removal of the pressure causes the washcoat composition to exit the microchannels.

Excess washcoat solvent may be removed from the channels after contacting with the washcoat composition. This may, for example, be by evacuating the washcoat composition from the channels using compressed air. Once the excess washcoat composition has been removed, the substrate may be dried at a suitable temperature (for example at a temperature of from 20 to 80° C. when the washcoat solvent comprises water).

When the high surface area refractory material comprises a metal oxide precursor such as boehmite, the method of the first aspect of the invention may further comprise converting the metal oxide precursor to the metal oxide. For example, when the high surface area refractory material is a metal oxide precursor (such as boehmite), the method of the first aspect of the invention may further comprise heating the substrate at a temperature required to convert the metal oxide precursor to a metal oxide (such as gamma-alumina). Suitable such temperatures may be 500 to 600° C., such as 540 to 560° C., for a period of 1 to 3 hours, for example 2 hours.

The washcoated substrate may comprise a functional species or precursor thereof in the solid washcoat layer. Alternatively or additionally, a functional species or precursor thereof may be applied to the washcoat layer after it has been formed.

The washcoated substrate may comprise a catalytic species or precursor thereof in the solid washcoat layer. Alternatively or additionally, a catalytic species or precursor thereof may be applied to the washcoat layer after it has been formed. In this case, the washcoated substrate may be contacted with a catalyst composition (comprising a catalytic species or precursor thereof) so as to deposit a catalytic species or precursor thereof onto the washcoat. Thus, the method of the first aspect of the invention may comprise applying a catalytic species or precursor thereof to the substrate. The catalytic species or precursor thereof may comprise a salt of a platinum group metal. For example, the catalyst composition may comprise an aqueous solution of the catalyst (for example salt of a platinum group metal), such that when the washcoated substrate is contacted with the catalyst composition, the aqueous solution is drawn into the pores of the washcoated substrate by capillary action and upon drying the salt ions combine to form agglomerates of the salt. These agglomerates are suitably then converted to platinum group metal by heating, for example to a temperature of 425 to 475° C.

The method of the first aspect of the invention may comprise:
(ia) contacting the substrate with a pre-treatment composition, wherein the pre-treatment composition comprises a first pre-treatment solvent and a hydrophobic compound;
(ib) removing the first pre-treatment solvent from the substrate to provide a pre-treated substrate; and
(iia) contacting the pre-treated substrate with a washcoat composition, wherein the washcoat composition comprises a washcoat solvent and a refractory material (such as a high surface area refractory material).

The method of the first aspect of the invention may comprise:
(ia) contacting the substrate with a pre-treatment composition, wherein the pre-treatment composition comprises a first pre-treatment solvent and a hydrophobic compound;
(ib) removing the first pre-treatment solvent from the substrate to provide a pre-treated substrate;
(iia) contacting the pre-treated substrate with a washcoat composition at a pressure of 20 to 200 kPa, wherein the washcoat composition comprises a washcoat solvent and a refractory material (such as a high surface area refractory material); and
(iii) removing the washcoat solvent from the substrate.

The method of the first aspect of the invention may comprise:
(ia) contacting the substrate with a second pre-treatment solvent so as to substantially saturate the pores of the substrate with the solvent and provide a pre-treated substrate; and
(ii) contacting the pre-treated substrate with a washcoat composition, wherein the washcoat composition comprises a washcoat solvent and a refractory material (such as a high surface area refractory material).

The method of the first aspect of the invention may comprise:
(ia) contacting the substrate with a second pre-treatment solvent so as to substantially saturate the pores of the substrate with the solvent and provide a pre-treated substrate;
(ii) contacting the pre-treated substrate with a washcoat composition, wherein the washcoat composition comprises a washcoat solvent and a refractory material (such as a high surface area refractory material); and
(iii) removing the washcoat solvent from the substrate.

According to a second aspect of the present invention, there is provided a washcoated porous ceramic substrate obtained by the method of the first aspect of the invention.

The present invention also provides a washcoated porous ceramic substrate obtainable by the method of the first aspect of the invention.

According to a third aspect of the present invention, there is provided a washcoated porous ceramic substrate comprising a plurality of micro-channels coated with a solid washcoat layer, wherein the quantity of the washcoat layer is proportional to the volume of the micro-channels.

The method of the first aspect of the invention enables the preparation of a washcoated porous ceramic substrate in which the micro-channels are coated with a solid washcoat layer such that the quantity of the washcoat layer is proportional to the volume of the micro-channels. In the process of the first aspect of the invention, the pre-treatment ensures that when the substrate is contacted with the washcoat composition, the washcoat composition fills the micro-channels (and not the pores). This results in the quantity of the washcoat layer being proportional to the volume of the micro-channels. This is advantageous because it enables tuning of the washcoat layer throughout the substrate to provide the desired characteristics for the required application.

According to a fourth aspect of the present invention, there is provided a method of manufacturing a filter, the method comprising manufacturing a washcoated porous ceramic substrate according to the first aspect of the invention and blocking at least some channels in the substrate. The method of the fourth aspect of the invention may further comprise applying a catalytic species or precursor thereof to the substrate. The method of the fourth aspect may further comprise applying a functional species, for example to aid filtration and/or cleansing.

When channels are blocked, the composition being filtered (such as a fluid, for example an exhaust gas or water) may be forced through the channel walls such that solid particles larger than the pores, which are carried in a fluid being passed through the substrate, become trapped in the substrate. The substrate can therefore act as a filter for such particles.

Suitably, the method comprises blocking at least 50%, such as at least 70%, or even at least 90% of the channels in the substrate. Preferably, the method comprises blocking all of the channels in the substrate. Suitably, adjacent channels are blocked at different surfaces of the substrate.

A substrate comprising a plurality of parallel, fused hollow fibres may comprise a plurality of parallel channels, which channels may be blocked.

In the method of the fourth aspect of the invention a washcoat composition comprising a refractory material (for example a high surface area refractory material) is applied to the pre-treated substrate. The refractory material (for example high surface area refractory material) may change the filtration properties of the substrate, such as reducing the size of particles that can pass through the substrate. The refractory material (for example high surface area refractory material) is as defined herein. The high surface area refractory material may suitably comprise alumina, silica, titania, silicon carbide and/or zirconia. Such materials may be used for water filtration.

The method of the fourth aspect of the invention may further comprise applying a dense ceramic material to the substrate. By “dense ceramic material” we mean a ceramic material which does not comprise pores. The dense ceramic material may be used for the separation of gases. The dense ceramic material may comprise yttrium stabilised zirconia or zirconia doped with yttrium, which may be used for oxygen separation. The dense ceramic material may be applied to the substrate by means of the washcoat composition or by application of a further coating to the washcoated substrate.

When the substrate has a catalytic species or precursor thereof applied thereto, the filter may comprise a combined filter-catalytic convertor. In the combined filter-catalytic convertor, the filter and catalytic convertor components may comprise the same or different washcoated substrates.

The method of the fourth aspect of the invention may further comprise applying a functional species for example comprising a suitable form of silver (such as silver ions) that acts to eradicate bacteria in the ceramic substrate and material being filtered.

According to a fifth aspect of the present invention, there is provided a method of filtering, the method comprising manufacturing a filter according to the fourth aspect of the invention and passing a composition through the filter.

The composition passed through the filter suitably comprises a mixture of substances, such as a solid and a liquid, a solid and a gas, a liquid and a gas, a mixture of solids, a mixture of liquids, and/or a mixture of gases. The filter suitably retains at least one of the substances in the mixture, while allowing other substances in the mixture to pass through. Suitably, the composition comprises a liquid or a gas. Preferably, the composition comprises a mixture of a solid and a gas or a mixture of a solid and a liquid. Alternatively, the composition may comprise a liquid and a gas, a mixture of liquids, and/or a mixture of gases.

Suitably, the composition passed through the filter comprises solid particles to be filtered, i.e. solid particles larger than the pores in the substrate. For example, the composition may comprise particles of soot. The composition may be exhaust fumes, such as from an internal combustion engine. Preferably, the internal combustion engine is a diesel or gasoline engine. For example, the composition may comprise an aqueous composition that comprises particulates.

The filter may operate in the nanofiltration range, so as to filter molecules in solution. For example the filer may have a molecular weight cut-off (MWCO) of 200 gmol⁻¹ (i.e. such that molecules larger than this would be separated).

The method of the fifth aspect of the invention may further comprise regenerating the filter by removing solid particles that have been trapped by the filter. Regeneration may be carried out by heating the filter to combust the solid particles. The filter may be heated to a temperature of at least 300° C., such as at least 400° C., or even at least 500° C. Suitably the filter is heated to a temperature of from 300 to 800° C., such as from 400 to 700° C., or even from 500 to 600° C.

The method of the fifth aspect of the invention may comprise manufacturing a combined filter-catalytic convertor and passing a pollutant composition through the combined filter-catalytic convertor. In the combined filter-catalytic convertor, the filter and catalytic convertor components may comprise the same or different washcoated substrates. Preferred features of the pollutant composition may be as defined herein.

According to a sixth aspect of the present invention, there is provided a filter comprising a washcoated porous ceramic substrate according to the second or third aspect of the invention.

The filter may be a diesel particulate filter a or gasoline particulate filter.

The filter may be for filtering a solid from a gas (for example a flue gas), such as for use in a stove (for example a wood or solid fuel burning stove).

The filter may be used in a process of selective catalytic reduction.

Alternatively, the filter may be a filter for liquid, such as a water filter. The filter for liquid suitably comprises a coating comprising a refractory material, such as alumina, silica, titania, silicon carbide and/or zirconia. The filter for a liquid, such as a water filter, may provide microfiltration, ultrafiltration or nanofiltration.

Alternatively, the filter may be a filter for the separation of gases, such as the separation of oxygen. The filter for the separation of gases suitably comprises a coating comprising a dense ceramic material, such as yttrium stabilised zirconia or zirconia doped with yttrium.

According to a seventh aspect of the present invention, there is provided a method of manufacturing a catalytic convertor, the method comprising manufacturing a washcoated porous ceramic substrate according to the first aspect of the invention and optionally depositing a catalytic species or precursor thereof on the washcoat. It may be required to deposit a catalytic species or precursor thereof on the washcoat if the washcoat does not comprise a catalytic species or precursor thereof.

According to an eighth aspect of the present invention, there is provided a method of catalytic conversion of pollutants, the method comprising manufacturing a catalytic convertor according to the seventh aspect of the invention and passing a pollutant composition through the catalytic convertor.

The pollutant composition may comprise one or more of particulate matter, hydrocarbons, carbon monoxide, and nitrogen oxides. Suitably, the pollutant composition is exhaust fumes, such as from an internal combustion engine. The internal combustion engine may be a gasoline engine or a diesel engine.

According to a ninth aspect of the present invention, there is provided a catalytic convertor comprising a washcoated porous ceramic substrate according to the second or third aspects of the invention.

In the case of a catalytic convertor, the washcoat covers the substrate, with the catalyst dispersed in the washcoat. The exhaust is vented through the catalytic convertor, where a chemical reaction takes place to convert some of the toxins into safer chemical compounds.

According to a tenth aspect of the present invention, there is provided a method of manufacturing an exhaust system, the method comprising:
manufacturing a filter according to the fourth aspect of the invention and incorporating the filter into an exhaust system; and/or
manufacturing a catalytic convertor according to the seventh aspect of the invention and incorporating the catalytic convertor into an exhaust system.

According to an eleventh aspect of the present invention, there is provided an exhaust system comprising a filter according to the sixth aspect of the invention and/or a catalytic convertor according to the ninth aspect of the invention.

According to a twelfth aspect of the present invention, there is provided a method of manufacturing a product including an internal combustion engine (such as a vehicle), the method comprising manufacturing an exhaust system according to the tenth aspect of the invention and incorporating the exhaust system into a product including an internal combustion engine (such as a vehicle).

According to a thirteenth aspect of the present invention, there is provided a product including an internal combustion engine (such as a vehicle) comprising an exhaust system according to the eleventh aspect of the invention.

Examples of products including an internal combustion engine include vehicles (including marine vehicles), tools (such as handheld tools, for example chainsaws) and generators.

The present invention further provides a method of manufacturing a vehicle, the method comprising manufacturing an exhaust system according to the tenth aspect of the invention and incorporating the exhaust system into a vehicle.

The present invention further provides a vehicle comprising an exhaust system according to the eleventh aspect of the invention.

The vehicle suitably comprises an internal combustion engine, such as a diesel engine or a gasoline engine. Examples of suitable vehicles include motorcycles, cars, vans, buses, lorries, boats, ships, industrial vehicles and agricultural vehicles.

### BRIEF DESCRIPTION OF DRAWINGS

For a better understanding of the invention, and to show how exemplary embodiments of the same may be carried into effect, reference will be made, by way of example only, to the accompanying diagrammatic Figures, in which:

FIG. 1 shows a schematic representation of a method according to the first aspect of the invention.

FIG. 2 shows a schematic representation of a method according to the first aspect of the invention

FIG. 3 shows an SEM image of the washcoated substrate of Example 2;

FIG. 4 shows an SEM image of the washcoated substrate of Example 2; and

FIG. 5 shows an SEM image of the washcoated substrate of the comparative example.

### DETAILED DESCRIPTION OF DRAWINGS

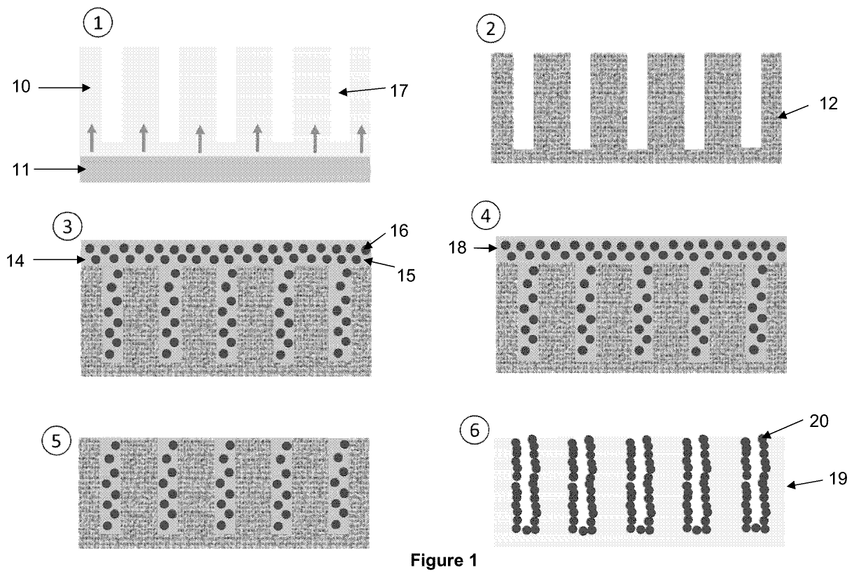

FIG. 1 shows a schematic representation of a method according to the first aspect of the invention in which the pre-treatment of the substrate prior to contacting with the washcoat composition comprises contacting the substrate with a second pre-treatment solvent so as to substantially saturate the pores of the substrate with the solvent.

FIG. 1 shows steps 1 to 6 of a method of the first aspect of the invention. In step 1, the substrate 10 is placed on a slab of porous material 11 soaked with water. The water is absorbed from the slab of porous material 11 into the substrate by capillary action, as shown by the arrows in FIG. 1. This provides a saturated substrate 12 in which the pores are substantially saturated with water, as shown in step 2 of FIG. 1.

In step 3 of FIG. 1, the saturated substrate 12 is contacted with a washcoat composition (14) comprising a washcoat solvent (such as water) 15 and a metal oxide (such as gamma-alumina) 16. In step 4 excess fluid is removed from the channels by applying compressed air 18, so as to provide a substrate in which the micro-channels are filled with the washcoat fluid as shown in step 5 of FIG. 1. In step 6 of FIG. 1, the washcoat solvent (water) is removed from the substrate by heating or drying, so as to provide a washcoated substrate 19 in which the washcoat has formed a layer 20 on the surfaces of the micro-channels.

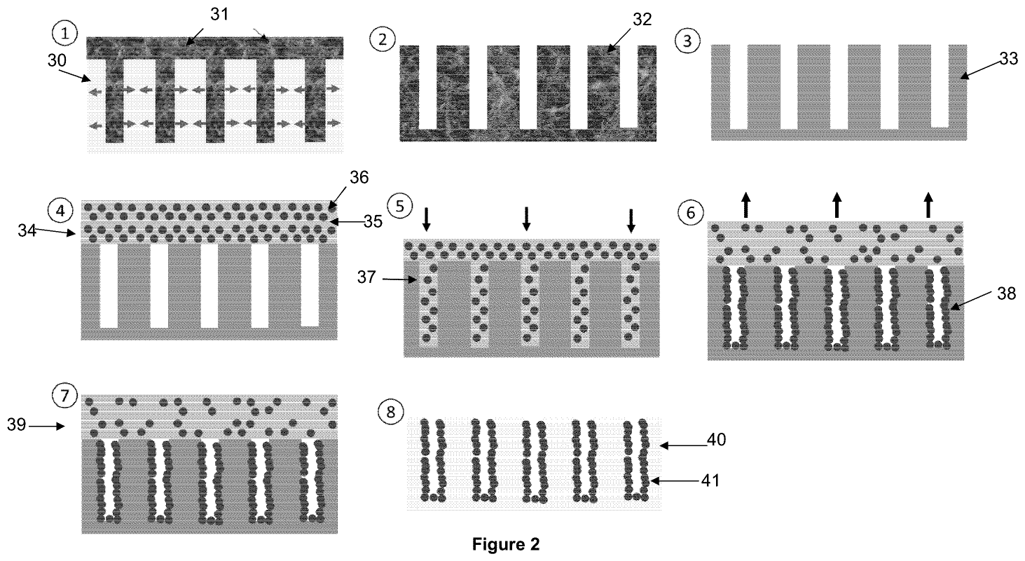

FIG. 2 shows a schematic representation of a method according to the first aspect of the invention in which the pre-treatment of the substrate prior to contacting with the washcoat composition comprises contacting the substrate with a pre-treatment composition, wherein the pre-treatment composition comprises a first pre-treatment solvent and a hydrophobic compound.

FIG. 2 shows steps 1 to 8 of a method of the first aspect of the invention. In step 1, the substrate 30 is immersed in a pre-treatment composition 31. The pre-treatment composition 31 is absorbed into the substrate by capillary action, as shown by the arrows in step 1 of FIG. 2.

This provides a saturated substrate 32 in which the pores are substantially saturated with the pre-treatment composition, as shown in step 2 of FIG. 2.

In step 3 of FIG. 2, the substrate is heated so as to remove the first pre-treatment solvent and provide a dry, hydrophobic substrate 33 as shown in step 3 of FIG. 2.

In step 4 of FIG. 2, the dry hydrophobic substrate 33 is contacted with a washcoat composition 34 comprising a washcoat solvent (such as water) 35 and a metal oxide (such as gamma-alumina) 36. In step 5, pressure is applied to the substrate to ensure that the washcoat composition floods the micro-channels 37 of the substrate. When the pressure is released in step 6, the washcoat composition exits the micro-channels leaving a washcoat residue 38 on the surfaces of the micro-channels. In step 7, excess fluid is removed from the channels by applying compressed air 39. In step 8 of FIG. 2, the washcoat solvent (water) and hydrophobic compound are removed from the substrate by heating, so as to provide a washcoated substrate 40 in which the washcoat has formed a layer 41 on the surfaces of the micro-channels.

### EXAMPLES

The invention will now be described with reference to the following non-limiting examples.

Scanning electron microscope (SEM) images were obtained using a Phenom ProX desktop Scanning electron microscope (SEM). The settings used were an acceleration voltage of 15 kV and the backscattered electron detector. SEM samples were prepared by breaking the washcoated sample to expose a region at the sample centre. No further changes to the sample were made before analysis.

The washcoat loading was calculated using the following equation:

$$( \frac{{weight}_{after} - {weight}_{before}}{{weight}_{before}} ) \times 100$$

### Example 1

A washcoat fluid was prepared by mixing boehmite and deionized water at a loading of 15 and 85 wt % respectively. The components were mixed in a vessel at a rate of 1500 rpm for 15 hours (until complete dispersion of the boehmite in water was achieved).

The substrate was immersed in a 95:5 (by weight) solution of ethanol and caprylic acid respectively, for 2 minutes. The substrate was then removed from the ethanol and caprylic acid mixture and dried at 80° C. for 15 minutes (to remove the ethanol).

The substrate was then weighed, and the weight recorded. The substrate was then submerged in the washcoat fluid in a sealed container connected to a source of compressed air. A pressure of 1 bar was applied for 20 seconds after the substrate was submerged in the washcoat fluid. The pressure was then released, the sample removed from the container and any remaining fluid evacuated from the substrate channels using compressed air. The substrate was then dried at a temperature of 80° C. for 1 hour (to remove the deionized water). After drying, the substrate was fired at 550° C. for 2 hours to convert the boehmite washcoat material to gamma-alumina. The substrate was then weighed to determine the washcoat loading.

### Example 2

A washcoat fluid was prepared by mixing boehmite and deionized water at a loading of 15 and 85 wt % respectively. The components were mixed in a vessel at a rate of 1500 rpm for 15 hours (until complete dispersion of the boehmite in water was achieved).

The substrate was weighed, and the weight recorded. The substrate was then placed on a slab of porous aluminium oxide soaked with water. The substrate was left on the slab for a period of 15 minutes for complete wetting to occur. After 15 minutes the substrate was removed from the porous material and evacuated with compressed air (to remove any excess water in the channels). The substrate was then submerged in the washcoat fluid in a sealed container for 10 minutes. The substrate was then removed from the container and any remaining washcoat fluid was evacuated from the substrate channels using compressed air. The substrate was then dried at a temperature of 80° C. for 1 hour (to remove the deionized water). After drying, the substrate was fired at 550° C. for 2 hours to convert the boehmite washcoat material to gamma-alumina. The substrate was then weighed to determine the washcoat loading.

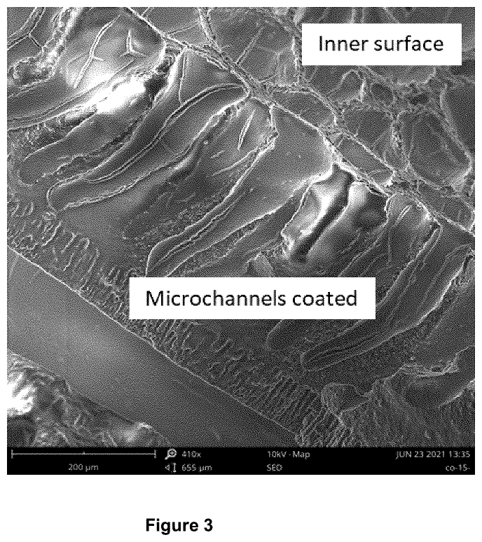

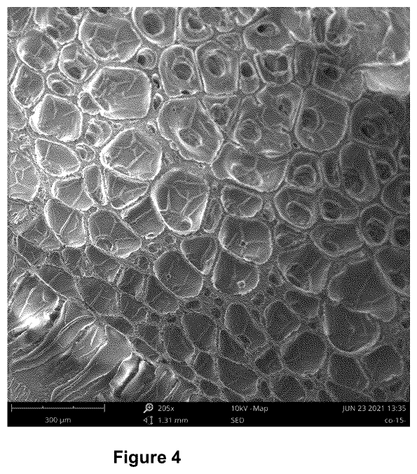

FIGS. 3 and 4 show the results of the washcoating method. FIGS. 3 and 4 show that there is a coating of washcoat within the micro-channels and on the inner surface without any plugs or cake layer formation. In particular, FIG. 3 shows that the micro-channels are coated.

The washcoat loading (g washcoat per g of substrate) was 2.2%.

### COMPARATIVE EXAMPLE

The comparative example uses a conventional washcoating method to apply a washcoat dispersion to a ceramic substrate. This conventional washcoating method relies on the transfer of water from the washcoat fluid to the dry substrate through capillary forces.

A washcoat fluid was prepared by mixing boehmite and deionized water at a loading of 15 and 85 wt % respectively. The components were mixed in a vessel at a rate of 1500 rpm for 15 hours (until complete dispersion of the boehmite in water was achieved).

The substrate was weighed, and the weight recorded. The substrate was then submerged in the washcoat fluid in a sealed container. The substrate was left submerged in the washcoat fluid for 10 minutes. The substrate was removed from the container and any remaining fluid was evacuated from the substrate channels using compressed air. The substrate was then dried at a temperature of 80° C. for 1 hour to remove the deionized water. After drying, the substrate was fired at 550° C. for 2 hours to convert the boehmite washcoat material to gamma-alumina. The substrate was then weighed and the washcoat loading was calculated.

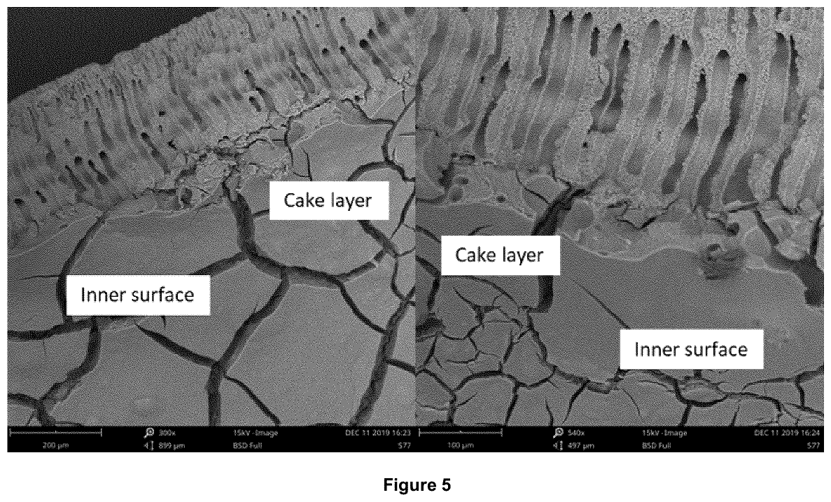

FIG. 5 shows the results of the conventional washcoating method. There is a “cake layer” of washcoat material that has been deposited on the inner fibre surface (walls of substrate channels), but the method failed to coat the micro-channels of the substrate.

The washcoat loading (g washcoat per g of substrate) was 2.5%.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of washcoating a porous ceramic substrate, the method comprising:
(i) pre-treating the substrate to form a pre-treated substrate;
(ii) contacting the pre-treated substrate with a washcoat composition, wherein the washcoat composition comprises a washcoat solvent and a refractory material (such as a high surface area refractory material),
wherein step (i) comprises pre-treating the substrate so as to substantially prevent ingress of the washcoat solvent into pores of the substrate and wherein the porous ceramic substrate comprises a plurality of channels and a plurality of micro-channels.

2. The method according to claim 1, wherein the ingress of the washcoat solvent into pores of the substrate is substantially prevented by reducing or preventing capillary action of the pores.

3. The method according to claim 1, wherein the refractory material (for example high surface area refractory material) comprises a ceramic material.

4. The method according to claim 1, wherein the refractory material (for example high surface area refractory material) comprises a metal oxide or precursor thereof.

5. The method according to claim 1, wherein the ingress of the washcoat solvent into pores of the substrate is prevented by increasing the hydrophobicity of the substrate.

6. The method according to claim 5, wherein step (i) comprises contacting the substrate with a pre-treatment composition, wherein the pre-treatment composition comprises a first pre-treatment solvent and a hydrophobic compound.

7. The method according to claim 6, further comprising removing the first pre-treatment solvent from the substrate.

8. The method according to claim 1, wherein the ingress of the washcoat solvent into pores of the substrate is prevented by substantially saturating the pores of the substrate with a second pre-treatment solvent.

9. The method according to claim 8, wherein step (i) comprises contacting the substrate with a second pre-treatment solvent so as to substantially saturate the pores of the substrate with the second pre-treatment solvent.

10. The method according to claim 1, wherein the pre-treated substrate is subjected to ultrasonication or to a pressure of 20 to 200 kPa upon contacting with the washcoat composition.

11. The method according to claim 1, further comprising removing the washcoat solvent from the substrate after contacting with the washcoat composition.

12. The method according to claim 1, further comprising applying a catalytic species or precursor thereof to the substrate.

13. A washcoated porous ceramic substrate obtained by the method of claim 1.

14. A washcoated porous ceramic substrate comprising a plurality of micro-channels coated with a solid washcoat layer, wherein the quantity of the washcoat layer is proportional to the volume of the micro-channels.

15. A method of manufacturing a filter, the method comprising manufacturing a washcoated porous ceramic substrate according to claim 1 and blocking at least some channels in the substrate.

16. A method of filtering, the method comprising manufacturing a filter according to claim 15 and passing a composition through the filter.

17. A filter comprising a washcoated porous ceramic substrate according to claim 13 or comprising a plurality of micro-channels coated with a solid washcoat layer, wherein the quantity of the washcoat layer is proportional to the volume of the micro-channels.

18. A method of manufacturing a catalytic convertor, the method comprising manufacturing a washcoated porous ceramic substrate according to claim 1 and optionally depositing a catalytic species or precursor thereof on the washcoat.

19. A method of catalytic conversion of pollutants, the method comprising manufacturing a catalytic convertor according to claim 18 and passing a pollutant composition through the catalytic convertor.

20. A catalytic convertor comprising a washcoated porous ceramic substrate according to claim 13 or comprising a plurality of micro-channels coated with a solid washcoat layer, wherein the quantity of the washcoat layer is proportional to the volume of the micro-channels.

21. A method of manufacturing an exhaust system, the method comprising:
manufacturing a filter and incorporating the filter into an exhaust system; and/or
manufacturing a catalytic convertor and incorporating the catalytic convertor into an exhaust system,
wherein the filter is manufactured by a method comprising manufacturing a washcoated porous ceramic substrate according to claim 1 and blocking at least some channels in the substrate and
wherein the catalytic convertor is manufactured by a method comprising manufacturing a washcoated porous ceramic substrate according to claim 1 and optionally depositing a catalytic species or precursor thereof on the washcoat.

22. An exhaust system comprising a filter and/or a catalytic convertor,
wherein the filter comprises a washcoated porous ceramic substrate obtained by the method of claim 1 or comprises a plurality of micro-channels coated with a solid washcoat layer,
wherein the catalytic converter comprises the washcoated porous ceramic substrate obtained by the method of claim 1 or comprises the plurality of micro-channels coated with a solid washcoat layer, and
wherein the quantity of the washcoat layer is proportional to the volume of the micro-channels.

23. A method of manufacturing a product including an internal combustion engine, the method comprising manufacturing an exhaust system according to claim 21 and incorporating the exhaust system into a product including an internal combustion engine.

24. A product including an internal combustion engine comprising an exhaust system according to claim 22.
